(19) United States
(12) Patent Application Publication
(10) Pub. No.: US 2018/0375400 A1
(43) Pub. Date: Dec. 27, 2018

(54) ELECTRIC MOTOR FOR A FLUID PUMP, MODULAR MOTOR FAMILY FOR FORMING DIFFERENT FLUID PUMPS WITH SEVERAL OF SUCH ELECTRIC MOTORS, AND PRODUCTION METHOD

(71) Applicant: Bühler Motor GmbH, Nürnberg (DE)

(72) Inventors: Matthias Ahrens, Nürnberg (DE); Andreas Wall, Nürnberg (DE); Georg Bernreuther, Nürnberg (DE); Arnold Scheer, Leipzig (DE); Olaf Richter, Stein (DE)

(73) Assignee: Bühler Motor GmbH, Nürnberg (DE)

(21) Appl. No.: 16/047,667

(22) Filed: Jul. 27, 2018

Related U.S. Application Data
(63) Continuation of application No. PCT/DE2017/200012, filed on Jan. 30, 2017.

(30) Foreign Application Priority Data
Feb. 4, 2016 (DE) 102016101963.1

(51) Int. Cl. H02K 5/08; H02K 3/52; H02K 5/132

(52) U.S. Cl. CPC H02K 5/08; H02K 5/132; H02K 3/522

(57) ABSTRACT

An electric motor for a fluid pump, in particular an oil pump, the electric motor comprising a housing in which a stator, a rotor, and a tapping plate are arranged, wherein the tapping plate comprises connecting contacts for the electrical connection to windings of the stator and connecting elements for connecting to an electronic control system and/or electronic positioning system, the tapping plate is formed or overmolded by a plastic material, and the stator is encased by an overmolding which forms a bearing seat for the rotor. The invention furthermore relates to a modular motor family for forming different, in particular differently powerful, fluid pumps comprising several brushless electric motors, wherein the individual electric motors differ from each other by different motor diameters and/or motor lengths and/or configuration variants. The invention furthermore relates to a production method for an electric motor.

### CROSS-REFERENCE TO RELATED APPLICATIONS

The present patent application is a continuation of International Application No. PCT/DE2017/200012, filed Jan. 30, 2017, which is based on, and claims priority from, German Application No. DE 102016101963.1, filed Feb. 4, 2016, both of which are incorporated herein by reference in their entireties.

### BACKGROUND OF THE INVENTION

(1) Field of the Invention

The invention relates to an electric motor for a fluid pump, in particular an oil pump. The invention furthermore relates to a modular motor family and a method for producing an electric motor for a fluid pump.

(2) Description of Related Art Including Information Disclosed Under 37 CFR 1.97 and 1.98

According to experience, electric motors are used to drive various vehicles and machines, including oil pumps. The functional principle of an electric motor is based on the conversion of electrical energy into mechanical energy. In doing so, the force exerted by a magnetic field on the current-carrying conductor of the electric motor is converted into movement and rotation.

As is known, brushless direct-current motors, so-called BLDC motors, are used for driving pumps for oil production. Such an electric motor is, for example, known from U.S. Pat. No. 6,788,015. The motor comprises a fixed stator, which contains coil windings, which may be controlled by an electronic circuit at different times. A rotatably mounted rotor is located in the stator. Rotors are generally realized with a permanent magnet. If an electric current flows in the stator windings, a magnetic field forms in the stator. This magnetic field also penetrates the permanent magnets of the rotor. Acting on the rotor is a torque, which sets the rotor into rotation. So that the rotation of the rotor does not stop, the current flow in the stator windings must be switched early enough so that the generated magnetic field continues to rotate and a torque continues to act on the rotor.

EP 1 523 087 A1 relates to an electric motor with a substantially closed motor housing which accommodates a rotor and a stator, with a motor flange which forms a section of the motor housing, with an electronic system for controlling the electric motor, and with a substantially closed electronic housing which accommodates the electronic system and is connected to the motor housing. In this case, the electronic housing and the motor housing form two separate housing units.

As described in EP 1 523 087 A1, the electronic system for controlling the motor is integrated into the electronic housing. By regulating the currents in the stators, a magnetic field of variable direction and size can be generated. The electronic system may include any type of electronic control system with which the electric motor can be controlled. The electronic control system typically depends on the motor. Direct-current motors need an electronic control system for commutating the electric supply currents to the individual stator windings. Alternating-current motors require an electronic system for regulating their rotational speed, for example.

In addition to the electronic control system, an electronic positioning system may also be introduced into the electronic housing. There are various ways of measuring the position of the rotor. For example, several Hall sensors may be mounted at the rotor end. The magnetic field changes generated by the rotation, and thus the position of the rotor, can be detected by the Hall sensor. By means of position sensors, a differentiated and efficient control of the torque of the motor is possible even at high speeds.

As a result of the great variety and the many possible uses of electric motors, work was mostly carried out in a customer-oriented manner in the past. This means that the previous motors were exclusively developed according to the wishes of the customer and according to the specific purpose of the motor. A flexible use of an electric motor for various areas of application is not provided thereby. The finished motors were neither suitable for new customer requests nor adaptable for use by others. As a consequence, customer-specific motors for a different purpose have to be produced de novo at high costs. This also results in additional high installation and repair costs.

The present invention is therefore based on the task of developing cost-effectively producible electric motors that are suitable for various applications with the smallest possible modification. Important in this respect is a modular structure of the electric motor that can be redesigned for a different purpose without much modification effort. It is furthermore the task of the invention to provide a modular motor family with comprehensive electric motors as well as a production method for an electric motor.

### BRIEF SUMMARY OF THE INVENTION

The present invention is based on the idea of providing an electric motor for a fluid pump, in particular an oil pump, the electric motor comprising a housing in which a stator, a rotor, and a tapping plate are arranged, wherein the tapping plate comprises connecting contacts for an electrical connection to windings of the stator and connecting elements for connecting to an electronic control system and/or electronic positioning system. The tapping plate is formed or overmolded by a plastic material, and the stator is encased by an overmolding that forms a bearing seat for the rotor.

The invention is furthermore based on the idea of providing a modular motor family for forming different, in particular differently powerful, fluid pumps, comprising several brushless electric motors, wherein each electric motor is made up of a housing in which a stator and a rotor and/or a tapping plate are arranged, wherein the tapping plate includes connecting contacts for an electrical connection to windings of the stator and connecting elements for connecting to an electronic control system and/or electronic positioning system, and the stator is encased by an overmolding which forms a bearing seat for the rotor, and wherein the individual electric motors differ from each other by different motor diameters and/or motor lengths and/or configuration variants.

A modular structure of an electric motor and the development of a motor family brings a multitude of advantages. As a result of the modularized and thus standardized motor structure, development and business process costs can be kept low. Structurally identical series of motor families are inexpensive in their production and ensure easier installation processes. With respect to the maintenance of motors, a modular structure can guarantee cost-effective repair. In particular, an easy replacement of faulty or damaged components can be achieved thereby.

A standardized structure moreover offers great flexibility in the product range as well as a diverse variety of products. If different modules of a motor are available, the motor can be adapted to new conditions quickly and easily. The standardized motor modules can simply be remounted, removed, changed, or grouped otherwise. Several customer-specific purposes can thus be realized using a modular motor structure.

In a preferred embodiment, the motor can have a smallest possible installation space. In this case, the motor comprises, for example, a housing in which a stator, a rotor, and a tapping plate are arranged. The tapping plate is made up of connecting contacts for electrical connection to the windings of the stator. The connecting contacts can, for example, be designed as flat plugs. With respect to the motor family of modularized motors, at least two different stator lengths and/or motor diameters are conceivable. With scalable motor lengths, a variety of applications can be covered.

The stator is preferably encased by an overmolding which forms a bearing seat for the rotor. The overmolding serves to seal the motor. The motor can thus be used in splash-water areas and a separation between wet and dry chambers can thus be ensured. The tapping plate is advantageously formed and/or overmolded by a plastic material, in particular a thermosetting material. Above all, the sensitive electronic system is ideally overmolded for the purposes of oil-tightness and is thus protected from external damage. It is conceivable that the tapping plate and the stator comprise the same, or a uniform, in particular a common, overmolding.

The tapping plate can advantageously be formed by a lead frame. Lead frames are particularly suitable in areas in which electric currents must be distributed in tight spaces. The lead frame itself can be encased in plastic. This again provides sealing and protection for the electronic system. It is conceivable for the surface of the lead frame also to be galvanically refined. The use of a lead frame is ideally space saving.

It is in particular advantageous in this connection if the tapping plate comprises at least two connecting elements. The connecting elements serve the electrical connection of the motor to an electronic system. The connecting elements of the tapping plate can in this case be aligned orthogonally or alternatively parallel to the tapping plate. The different alignment of the connecting elements allows for a varied alignment of the motor within the assembly and in relation to the fluid pump. In this embodiment, the stator overmolding preferably contains a plug housing for safely accommodating the connecting elements.

The tapping plate is ideally secured as by welding or hot-pressing to a plastic material or ceramic material. The invention is not limited to a plastic material or ceramic material. Other insulating materials, such as glass, are also conceivable. In an alternative embodiment, the tapping plate is glued to and/or bonded to and/or cast with and/or overmolded with a plastic material.

In an advantageous embodiment, the housing of the motor comprises an accommodation chamber for an electronic control system and/or electronic positioning system. The accommodation chamber can in this case be arranged axially or radially in relation to the motor axis. The accommodation chamber can be separated from the stator by a separating wall. A separation of the electronic system from the stator allows for simplified repair in the case of damage or malfunctioning since the electronic system is quickly accessible within the accommodation chamber.

The connecting elements advantageously extend through the separating wall. The separating wall can, for example, form a side wall or an axial end wall or an intermediate wall of the housing.

In a preferred embodiment, a circuit board for the electronic control system and/or electronic positioning system is mounted in the accommodation chamber. The circuit board can be connected or is connected electrically to the connecting elements. The circuit board and thus also the electronic system is ideally overmolded with a plastic material or ceramic material. This protects the sensitive electronic system from external damage and ensures oil tightness of the electrical connectors.

In an advantageous embodiment of the invention, the accommodation chamber of the electronic system is sealed using a cover. This cover can, for example, be provided with a rubber seal. The rubber seal can be an O-ring or be designed as a flat seal. Alternatively, the seal can be designed as liquid silicone-rubber injection molding or as injection-molded liquid silicone. The cover can be connected in a sealed manner to the accommodation chamber or to an accommodation pocket. This connection can be effected by a substance-to-substance bond or by a force fit, for example by gluing, welding, or screwing. A plug housing for the connecting elements of the tapping plate can integrally be molded onto the cover.

The overmolding ideally comprises a plastic material, in particular a thermosetting material, or alternatively a thermoplastic material. The plastic material of the housing can be designed to be integral or in one piece with the plastic material for overmolding the tapping plate and/or the circuit board. A thermosetting material has a high stiffness in order to protect the motor or the tapping plate with the electronic system from external deformation or damage. The thermosetting material moreover has a high thermal and chemical resistance.

A related aspect of the invention relates to a modular motor family for forming differently powerful fluid pumps with several comprehensive brushless electric motors. As a common feature, all electric motors have a housing in which a stator and a rotor and/or a tapping plate are arranged as well as an overmolding of the stator. The tapping plate comprises connecting contacts for the electrical connection to windings of the stator, as well as connecting elements for connecting to an electronic control system and/or electronic positioning system. The individual electric motors however differ by the following modular configuration features:
a. The electric motors can have different motor diameters and/or motor lengths. As a result, they are suitable for different machines as well as their different purposes.
b. The electric motors can comprise an electronic control system for controlling windings of the stator and/or at least one position sensor integrated into the electric motor.
c. The electronic system can be arranged in the housing.
d. The integration of the electronic control system or of an electronic positioning system is based on the performance principle and purpose of the particular motor.
e. The electronic positioning system allows precise control and positioning of the rotor in motors with high speeds and rotational speeds, for example.
f. A precise speed regulation, acceleration control, and position control are thus also ensured, for example.
g. An effective torque control ensures higher efficiency and prevents jerky and other undesired mechanical effects, which can be caused by torque fluctuations.

In one configuration variant, the housing can advantageously form an end-face accommodation chamber for the electronic control system and/or electronic positioning system at a longitudinal axial end. In this case, the tapping plate can comprise at least two connecting elements, which are aligned orthogonally to an annular face of the tapping plate and project into the end-face accommodation chamber.

In another configuration variant, the housing can alternatively form a circumferential accommodation chamber for the electronic control system and/or electronic positioning system on a circumference. The tapping plate can once again comprise at least two connecting elements, which are aligned parallel to an annular face of the tapping plate and project into the circumferential accommodation chamber.

The motor family can generally comprise several electric motors of different motor diameters and/or motor lengths, wherein the electric motors are equipped with or without position sensor and/or with or without electronic control system and are constructed in accordance with the structure of an electric motor described above. The possible configuration with different electronic system designs and/or motor lengths expands the usability of the motors for the most varied purposes, in particular in the area of fluid pumps and oil pumps. A great product variety is ensured thereby.

Another related aspect of the invention relates to a method for producing an electric motor with predetermined specifications for a fluid pump, in particular an oil pump. The method is suitable in particular for the production of an electric motor for a motor family with the previously explained features, wherein several standard components can be combined with each other in order to satisfy a previously determined specification. The standard components comprise one or more electric motors having different motor diameters and/or motor lengths, one or more different position sensors for integration into the electric motors, and/or one or more different electronic control systems for controlling the electric motors, wherein the electronic control systems can be arranged in an accommodation chamber of a housing of the electric motor.

### BRIEF DESCRIPTION OF THE SEVERAL VIEWS OF THE DRAWINGS

The present invention is explained in more detail below with reference to the accompanying schematic drawings. These show:

FIG. 1 is a perspective view of a stator of an electric motor according to the invention in accordance with a preferred exemplary embodiment;

FIG. 2 is a perspective view of an electric motor according to the invention in accordance with a preferred exemplary embodiment with a stator according to FIG. 1, rotor, and integrated tapping plate;

FIG. 3 is a perspective view of a plastic overmolded tapping plate of the electric motor according to FIG. 2;

FIG. 4 is a perspective view of a lead frame of the tapping plate according to FIG. 3;

FIG. 5 is a perspective view of a housing of the electric motor according to FIG. 2;

FIG. 6 is a perspective view of an alternative housing for the electric motor according to FIG. 2 with an accommodation chamber and an electronic positioning system integrated therein;

FIG. 7 is a perspective view of the housing according to FIG. 6 with mounted circuit board;

FIG. 8 is a perspective view of the housing according to FIG. 7 with attached cover and plug housing;

FIG. 9 is a perspective view of another alternative housing for the electric motor according to FIG. 2 with an accommodation chamber and an electronic control system integrated therein;

FIG. 10 is a perspective view of the housing according to FIG. 9 with mounted circuit board;

FIG. 11 is a perspective view of the housing according to FIG. 10 with attached cover and plug housing;

FIG. 12 is a perspective view of a housing for an electric motor according to the invention in accordance with another preferred exemplary embodiment, wherein the housing comprises a radially arranged accommodation chamber; and

FIG. 13 is a perspective view of the housing according to FIG. 12, wherein the accommodation chamber is closed by a cover with a plug housing.

### DETAILED DESCRIPTION OF THE INVENTION

In describing preferred embodiments of the present invention illustrated in the drawings, specific terminology is employed for the sake of clarity. However, the invention is not intended to be limited to the specific terminology so selected, and it is to be understood that each specific element includes all technical equivalents that operate in a similar manner to accomplish a similar purpose.

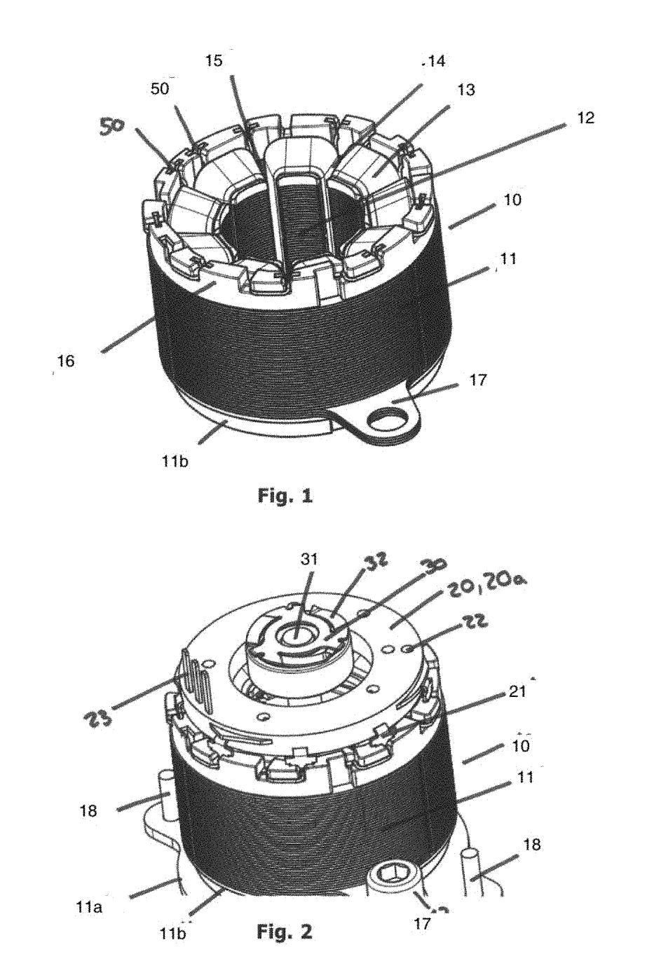

FIG. 1 shows a perspective view of a stator 10 of an electric motor according to the present invention in accordance with a preferred exemplary embodiment. The stator 10 comprises a stator lamination stack 11 and stator core 12. The stator core 12 encloses a hollow cylindrical internal space in which a rotor 30 can be accommodated. Several cylindrical stator teeth 13 can be mounted in the stator core 12. Between the stator teeth 13 are located longitudinal stator slots 14, wherein the stator slots 14 are designed to accommodate stator windings 15. The stator 10 can preferably comprise an electrical insulating layer in the area of the stator windings 15. The insulating layer can be an overmolded plastic layer. On the end face of the stator lamination stack 11 is located an insulating ring 16 for insulating the connecting contacts 21 of the tapping plate 20. In the insulating ring 16 are slit-shaped openings 50 so that the connecting contacts 21 of the tapping plate 20 can be connected to the ends of the stator windings 15. On the underside of the stator lamination stack 11 is mounted a screwing device 17 so that the stator lamination stack 11 can be connected by a force fit to the motor housing. The full view of the screwing device 17 is shown in Figure.

FIG. 2 illustrates a perspective view of an electric motor according to the invention in accordance with a preferred exemplary embodiment with a stator 10 according to FIG. 1, rotor 30, and integrated tapping plate 20. The cylindrical stator comprises a stator lamination stack 11 with a housing base 11a. On the housing base 11a is arranged an annular carrier component 11b onto which the stator lamination stack 11 is mounted. On the opposite side on the housing base 11a is located a screwing device 17 and an elongated screw connection 18. The housing base 11a can be connected to a motor housing by a force fit and by a form fit by means of the screwing device 17 and the screw connection 18. In the stator lamination stack 11, a stator core 12 is arranged but not visible here.

The tapping plate 20 can be mounted on an end face of the stator 10. The tapping plate 20 is designed as annular with an inner opening for the rotor 30. On the underside of the tapping plate 20, several connecting contacts 21 are mounted externally. These connecting contacts are, for example, designed as flat plugs. The connecting contacts 21 connect the tapping plate 20 to the stator windings 15, which are invisibly arranged in the stator core 12. The connecting contacts 21 are orthogonal to the tapping plate 20. The tapping plate 20 comprises three connecting elements 23 for the electric equipment of the motor. The connecting elements 23 are shown as elongated plugs and are aligned orthogonally to the tapping plate 20. Alternatively, the connecting elements 23 can also be arranged parallelly to the tapping plate 20. The tapping plate 20 has several circular recesses 22. The recesses 22 serve to connect additional electronic systems and additional connection contacts 24.

The electric motor comprises a rotor 30. The rotor shaft 31, on which a ball bearing 32 is mounted, runs in the center of the rotor 30. The rotor 30 is rotatably accommodated in the stator core 12.

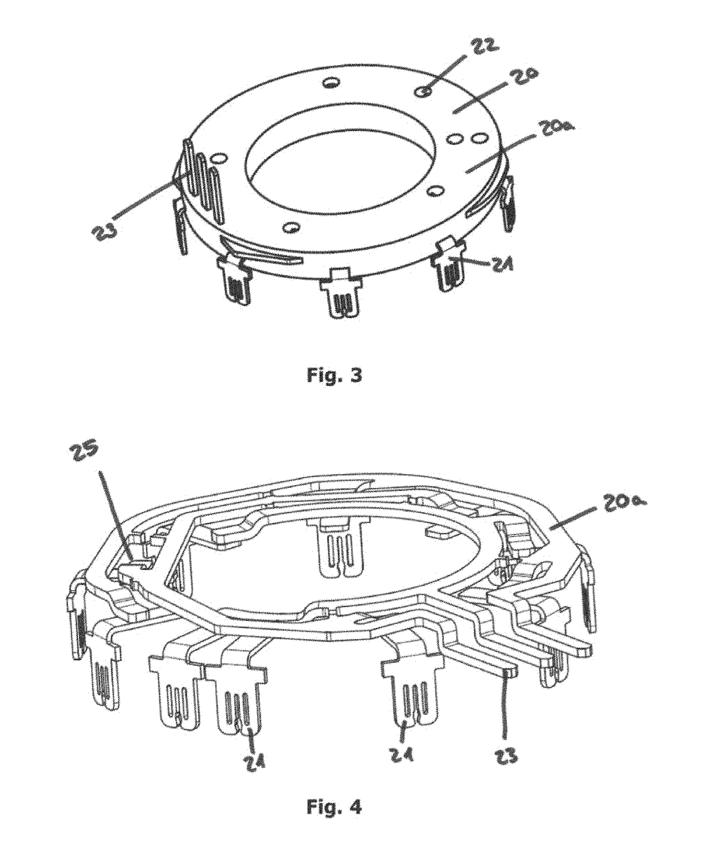

FIG. 3 shows a perspective view of a plastic overmolded tapping plate 20 of the electric motor according to FIG. 2. Overmolding is a process where a single part is created using two or more different materials in combination. Typically the first material, sometimes referred to as the substrate, is partially or fully covered by subsequent materials (overmold materials) during the manufacturing process. The tapping plate 20 can be mounted on an end face of the stator lamination stack 11 as illustrated in FIG. 2. The tapping plate 20 comprises a flat base body 20a. The base body 20a is annular and comprises an inner pass-through opening for the rotor 30. On the underside of the base body 20a, several connecting contacts 21 are mounted externally. These connecting contacts are, for example, designed as flat plugs. The connecting contacts 21 are orthogonal to the base body 20a. They can be integrally connected to the base body 20a or be mounted thereon by a substance-to-substance bond. The tapping plate 20 comprises three connecting elements 23 for the electric equipment of the motor. Alternatively, only two connecting elements can also be arranged. The connecting elements 23 are shown as elongated plugs and are orthogonal to the base body 20a. The tapping plate 20 comprises several circular recesses 22. After overmolding, the recesses 22 divide the base body 20a at defined points of the tapping plate 20 into the different electrical phases of the motor.

FIG. 4 shows a perspective view of a lead frame of the tapping plate 20 according to FIG. 3. The lead frame comprises a flat base body 20b onto which several connecting contacts 21 are mounted. The connecting contacts 21 are illustrated as flat plugs. The connecting contacts 21 can additionally be grouped in pairs. The flat plugs are orthogonal to the base body 20b. They connect the base body 20b to the stator windings 15. Three connecting elements 23 are designed to be integral with the lead frame. The elongated connecting elements 23 constitute the motor contacts for the electronic system. They extend parallel to the base body 20b of the lead frame, for example. The base body 20b additionally comprises several punch-outs 25. These punch-outs can have elongated or rectangular shapes. They allow for a division of the base body 20b into different electrical phases of the motor.

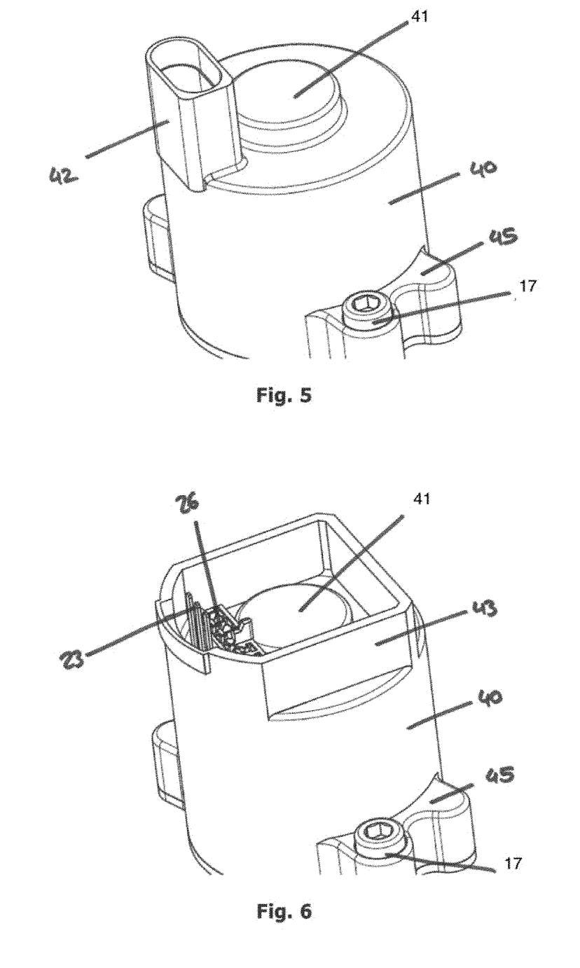

FIG. 5 shows a perspective view of a housing 40 of the electric motor according to FIG. 2. The cylindrical housing 40 can be formed from a plastic material, in particular a thermosetting material. The motor arrangement as illustrated in FIG. 2 is, for example, accommodated in the housing 40. On the outside on the end face, the housing 40 has a molded-on cuboidal plug housing 42 with rounded edges. The connecting elements 23 of the tapping plate 20 project invisibly into the plug housing 42. The plug housing 42 can be connected by a substance-to-substance bond to the housing 40, e.g., by gluing or welding or overmolding. The plug housing 42 can alternatively also be integrally molded with the housing 40. In its center, the end face of the housing 40 has a round bearing seat 41 for the rotor 30. On the underside of the housing 40 is located a covering 45 for the screwing device 17 and the screw connection 18 of the housing base 11a. The covering 45 has the same shape as the housing base 11a. As a result, the covering 45 can be connected to the housing base 11a by a force fit. The screw connection 17 projects from the covering 45. The screw connection 18 is invisibly accommodated in the covering 45. The mounting device of the housing base 11a is connected in a safe and sealed manner to the housing 40 of the motor by the covering 45.

FIG. 6 shows a perspective view of an alternative housing 40 for the electric motor according to FIG. 2 with an accommodation chamber 43 and an electronic positioning system integrated therein. The cylindrical housing 40 is constructed similarly to that in FIG. 5 without plug housing 42 and preferably has, on the end face, a molded-on cuboidal accommodation chamber 43 for the electronic positioning system for positioning of the rotor 30. The accommodation chamber 43 is hollow inside. In this embodiment, the accommodation chamber 43 is integrally formed with the housing 40. The accommodation chamber 43 constitutes a bounding frame of the electronic system. The accommodation chamber 43 can alternatively also be separated from the stator 10 by a separating wall. Since the electronic system is placed on the outside on the end face of the housing, the accommodation chamber 43 is rounded on this side so that the electronic system can be accommodated safely in the accommodation chamber 43. The shape of the accommodation chamber 43 can be adapted to the electronic system used.

For example, round, angular, or polygonal shapes for the accommodation chamber 43 are also conceivable. The size of the accommodation chamber 43 is ideally guided by the electronic system used. This means that the accommodation chamber 43 can also project beyond the housing. The round bearing seat 41 of the rotor 30 projects into the accommodation chamber 43. On the left side, the connecting elements 23 project from the accommodation chamber 43. For sealing, the accommodation chamber 43 can be closed by a substance-to-substance bond or by a force fit using a cover 46 (See FIG. 8). Next to the connecting elements is mounted a switching element 26 with several contact connectors for the electronic positioning system. On the underside of the housing, the same covering 45 is mounted as described in FIG. 5 in order to connect the housing 40 to the housing base 11a and to thus accommodate the motor in the housing 40 in a protected and sealed manner.

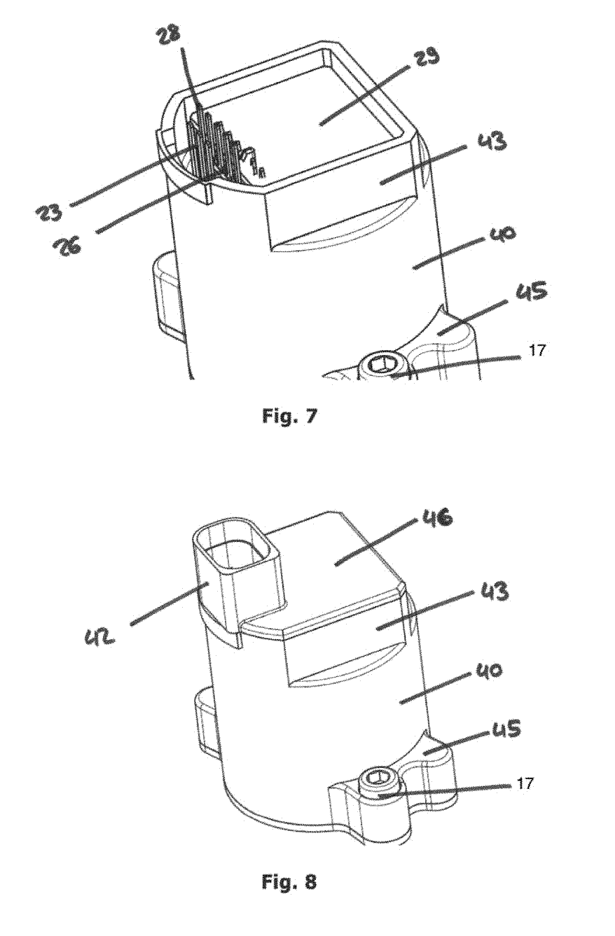

FIG. 7 shows a perspective view of the housing according to FIG. 6 with mounted circuit board 29. The circuit board 29 can comprise a position sensor on the side facing the motor. On the underside of the housing 40, the same covering 45 is mounted as described in FIG. 5 in order to connect the housing 40 to the housing base 11a. The accommodation chamber 43 for the electronic positioning system is illustrated as molded-on cuboidal frame with a rounded side in the vicinity of the electronic positioning system. The three elongated connecting elements 23 of the motor contacts project from the accommodation chamber 43. In contrast to FIG. 6, the switching element 26 of the electronic positioning system comprises several elongated plug contacts 28 in the contact connectors. The plugs are connected or can be connected to the circuit board 29. In this embodiment, the electronic system is, for example, overmolded with a plastic material. The overmolding can advantageously be a thermosetting material. The electronic system is thereby protected from external damage. The overmolding of the electronic system only fills out the lower part of the accommodation chamber 43 so that the electronic system is safely accommodated in the accommodation chamber 43. The plug contacts 28 of the electronic positioning system partially project from the overmolding.

FIG. 8 shows a perspective view of the housing according to FIG. 7 with attached cover 46 and plug housing 42. On the underside of the housing 40, the same covering 45 is mounted as described in FIG. 5 in order to connect the housing 40 to the housing base 11a. The accommodation chamber 43 for the electronic system is the same as shown in FIG. 6 and FIG. 7. The electronic system can in this case be overmolded with a plastic material as described in FIG. 7. FIG. 8 shows a possible variation of a cover 46 for the accommodation chamber 43 as it can be mounted onto the housing variations of FIGS. 6 and 7, for example.

The cover 46 has the same cuboidal shape with a rounded side that fits onto the accommodation chamber 43 for the electronic system. The cover 46 can be connected by a substance-to-substance bond to the accommodation chamber 43, e.g., by gluing, welding, or soldering. A mounting by force fit by means of a screw connection is also conceivable. The cover 46 is ideally connected in a sealed manner to the accommodation chamber 43 so that the electronic system can be accommodated in the accommodation chamber 43 in a protected manner. For this purpose, the cover 46 can be provided with a rubber seal not shown. This rubber seal can, for example, be an O-ring or a flat seal. A plug housing 42 is integrally molded onto the cover 46. The plug housing 42 is cuboidal with rounded edges and stands orthogonally on the cover 46. The plug housing 42 can alternatively also be mounted on the cover 46 by a substance-to-substance bond. The plug housing 42 protects the three connecting elements 23, which project from the tapping plate 20 into the accommodation chamber 43 of the electronic system and also partially from the accommodation chamber 43.

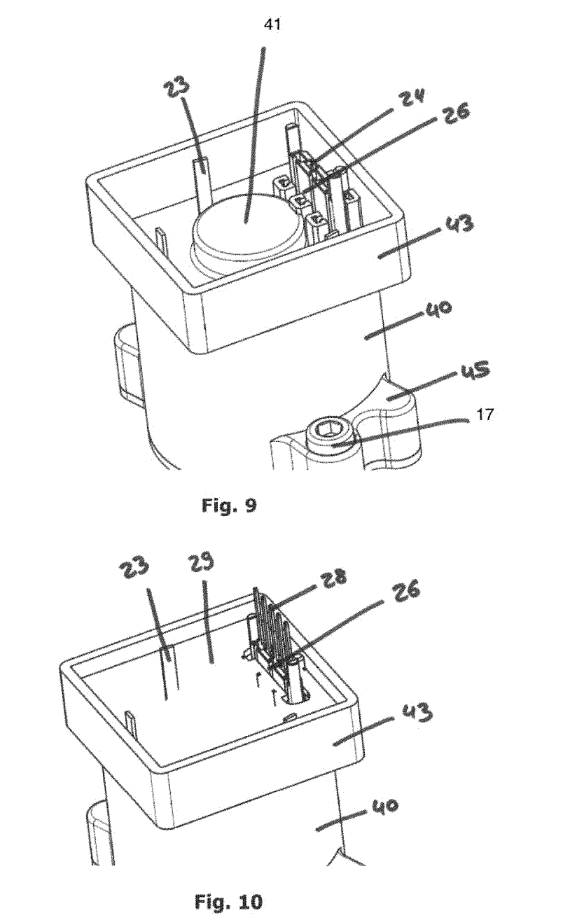

FIG. 9 shows a perspective view of yet another alternative housing 40 for the electric motor according to FIG. 2 with an accommodation chamber 43 and an electronic control system integrated therein. On the underside of the housing 40, the same covering 45 is mounted as described in FIG. 5 in order to connect the housing 40 to the housing base 11a. The accommodation chamber 43 for the electronic system constitutes a cuboidal frame on the end face of the housing 40. In contrast to FIGS. 6 to 8, the accommodation chamber 43 is larger than the end face of the housing 40. The accommodation chamber 43 thus projects beyond the housing 40 of the motor. The accommodation chamber 43 can be integrally connected to the housing 40. A connection to the housing 40 by a substance-to-substance bond or by a force fit is also conceivable. In the center of the accommodation chamber 43, the round bearing seat 41 for the rotor 30 is visible. In the accommodation chamber 43, several elongated connecting elements 23 are variably accommodated. The electronic control system comprises a switching element 26 close to the bearing seat 41 for the rotor 30. The switching element 26 consists of several hollow cylindrical connection contacts 24.

FIG. 10 shows a perspective view of the housing 40 according to FIG. 9 with mounted circuit board 29. On the underside of the housing 40, the same covering 45 is mounted as described in FIG. 5 in order to connect the housing 40 to the housing base 11a. The accommodation chamber 43 for the electronic control system is shown as in FIG. 9 as a molded-on cuboidal frame. In contrast to FIG. 9, the switching element 26 comprises several thin elongated plug contacts 28 in the cylindrical connection contacts 24. The plugs are connected or can be connected to the circuit board 29. The plug contacts 28 project from the accommodation chamber 43. In this embodiment, the electronic control system is, for example, overmolded with plastic material as in FIG. 7. This overmolding can advantageously be a thermosetting material. The overmolding of the electronic system only fills the lower part of the accommodation chamber 43 so that the electronic system is safely accommodated in the accommodation chamber 43. The plug contacts 28 of the electronic control system partially project from the overmolding.

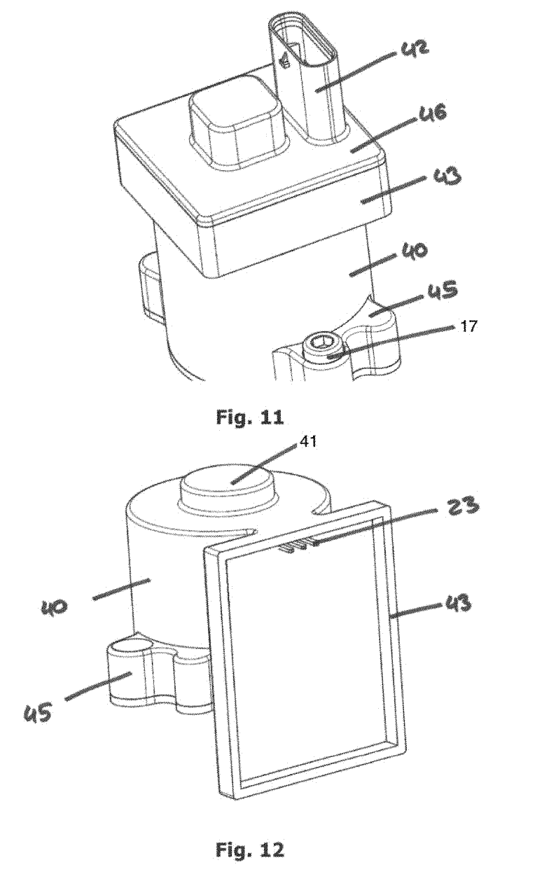

FIG. 11 illustrates a perspective view of the housing 40 according to FIG. 10 with attached cover 46 and plug housing 42. On the underside of the housing 40, the same covering 45 is mounted as described in FIG. 5 in order to connect the housing 40 to the housing base 11a. The accommodation chamber 43 for the electronic system is the same as shown in FIG. 9 and FIG. 10. The electronic system can in this case be overmolded with plastic material as described in FIG. 10. FIG. 11 shows a variation of a cover 46 for the accommodation chamber 43 as it can be mounted onto the housing variations of FIGS. 9 and 10, for example. The cover 46 has the same cuboidal shape as the accommodation chamber 43 of the electronic control system. The cover 46 can be connected by a substance-to-substance bond to the accommodation chamber 43, e.g., by gluing, welding, or soldering. A mounting by a force fit by means of a screw connection is also conceivable. The cover 46 is ideally connected to the accommodation chamber 43 in a sealed manner. For this purpose, the cover 46 can be provided with a rubber seal not shown as described by way of example for FIG. 8. A plug housing 42 is integrally molded onto the cover. The plug housing 42 is cuboidal with rounded edges and stands orthogonally on the cover 46.

FIG. 12 shows a perspective view of a housing 40 for an electric motor according to the invention in accordance with another preferred exemplary embodiment, wherein the housing 40 comprises a radially arranged accommodation chamber 43. On the underside of the housing 40, the same covering 45 is mounted as described in FIG. 5 in order to connect the housing 40 to the housing base 11a. In contrast to FIGS. 5 to 10, the accommodation chamber 43 for the electronic system is now mounted not on the end face of the housing 40 but radially to the motor axis. The housing 40 only shows the bearing seat 41 of the rotor 30 on the end face of the motor. The cuboidal accommodation chamber 43 projects beyond the length of the motor. The accommodation chamber 43 is integrally connected to the housing 40 of the motor. In this embodiment, the three connecting elements 23 of the tapping plate 20 extend parallelly to the tapping plate 20. They project into the accommodation chamber 43. For protection, the electronic system can be partially overmolded in the accommodation chamber 43 with a plastic material.

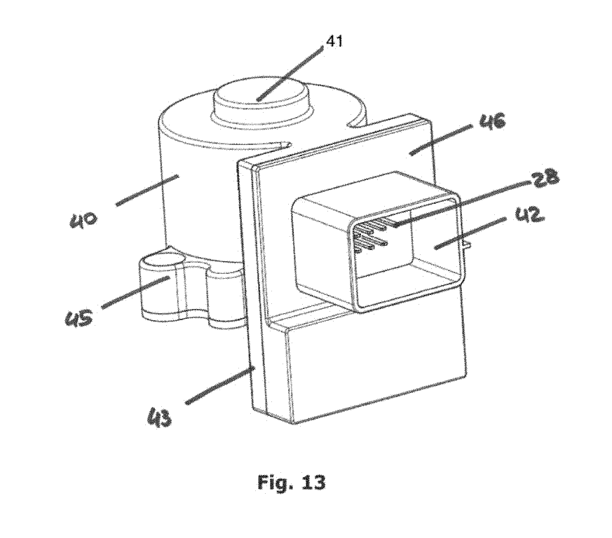

FIG. 13 shows a perspective view of the housing 40 according to FIG. 12, wherein the accommodation chamber 43 is closed by a cover 46 with a plug housing 42. On the underside of the housing 40, the same covering 45 is mounted as described in FIG. 5 in order to connect the housing 40 to the housing base 11a. As described in FIG. 12, the accommodation chamber 43 for the electronic system is mounted radially to the motor axis and connected integrally to the housing 40. The embodiment illustrated shows a cover 46 with molded-on plug housing 42 for a radial accommodation chamber 43. The cover 46 is ideally connected in a sealed manner to the accommodation chamber 43 so that the electronic system can be arranged in the accommodation chamber 43 in a protected manner. For this purpose, the cover 46 can be provided with a rubber seal not shown. The elongated plug contacts 28 of the electronic system of the accommodation chamber 43 project into the plug housing 42.

The described modular structure of the electric motors with variable stator length and variable electronic control and positioning system allows for flexible and versatile use of the motors in the field of fluid pumps. In order to realize different possible electronic systems, the housing variations described in FIGS. 5 to 13 can be used. Other combinations of the features of the housing 40 depending on the purpose and use of the motor are conceivable. The accommodation chamber 43 for the electronic system can, for example, project beyond the housing 40 or be mounted radially on the housing 40. The accommodation chamber 43 can be formed integrally with the housing 40 or be separated from the stator 10 by a separating wall. The separating wall can be a side wall or an axial end wall or an intermediate wall of the housing 40. The shape of the accommodation chamber 43 and of the plug housing 42 can be different in all motor variations. For example, round, angular, or polygonal shapes for the accommodation chamber 43 and/or for the plug housing 42 are also conceivable. The accommodation chamber 43 can be mounted radially or axially on the housing 40.

Modifications and variations of the above-described embodiments of the present invention are possible, as appreciated by those skilled in the art in light of the above teachings. It is therefore to be understood that, within the scope of the appended claims and their equivalents, the invention may be practiced otherwise than as specifically described.

### LIST OF REFERENCE SYMBOLS

10 Stator

11 Stator lamination stack

11a Housing base

11b Carrier component

12 Stator core

13 Stator tooth

14 Stator slot

15 Stator winding

16 Insulating ring

17 Screwing device

18 Threaded connection

20 Tapping plate

20a Base body

21 Connecting contact

22 Recess

23 Connecting element

24 Connection contact

25 Punch-out

26 Switching element

28 Plug contact

29 Circuit board

30 Rotor

31 Rotor shaft

32 Ball bearing

40 Housing

41 Bearing seat

42 Plug housing

43 Accommodation chamber

45 Covering

46 Cover

50 Opening

What is claimed is:

1. An electric motor having an electronic control system, the electric motor comprising:
a stator having a stator core and windings;
a rotor mounted in the stator core;
an overmolding for encasing the stator and forming a bearing for the rotor;
a tapping plate formed from a first plastic material and having connecting contacts for electrical connection to the windings of the stator and connecting elements for connecting to the electronic control system; and
a housing in which the stator, the rotor, and the tapping plate are arranged.

2. The electric motor according to claim 1, wherein the tapping plate is formed by a lead frame.

3. The electric motor according to claim 2, wherein the tapping plate comprises at least two connecting elements which are aligned substantially orthogonally or parallel to the tapping plate.

4. The electric motor according claim 1, wherein the tapping plate is secured to a plastic material or ceramic material.

5. The electric motor according to claim 1, wherein the housing comprises an accommodation chamber for the electronic control system, said accommodation chamber being separated from the stator by a separating wall.

6. The electric motor according to claim 5, wherein the connecting elements extend through the separating wall, and wherein the separating wall forms a side wall or an axial end wall or an intermediate wall of the housing.

7. The electric motor according to claim 1, further comprising:
a circuit board forming part of the electronic control system, the circuit board being mounted in the accommodation chamber.

8. The electric motor according to claim 7, wherein the circuit board can be connected electrically to the connecting elements.

9. The electric motor according to claim 1 wherein the electronic control system is overmolded with a plastic material or ceramic material.

10. The electric motor according to claim 1, wherein the overmolding comprises a second plastic material that is formed integrally or with the first plastic material for overmolding the tapping plate and/or the circuit board.

11. A modular motor family for forming different fluid pumps, the modular motor family comprising several brushless electric motors, wherein each electric motor includes a housing in which a stator with windings and a rotor and a tapping plate are arranged, wherein
the tapping plate comprises connecting contacts for electrical connection to the windings of the stator and connecting elements for connecting to an electronic control system, and
the stator is encased by an overmolding which forms a bearing seat for the rotor, and
wherein the individual electric motors differ from each other by different motor diameters and/or motor lengths and/or configuration variants, wherein the configuration variants have the following configuration features:
an electronic control system for controlling windings of the stator, said electronic control system being arranged in the housing, and/or
at least one position sensor integrated into the electric motor.

12. The motor family according to claim 11, wherein the housing forms an end-face accommodation chamber for the electronic control system at a longitudinal axial end of at least one of the motors.

13. The motor family according to claim 12, wherein the tapping plate comprises at least two connecting elements, which are aligned orthogonally to an annular face of the tapping plate and project into the end-face accommodation chamber.

14. The motor family according to claim 11, wherein, on a circumference the housing a circumferential accommodation chamber for the electronic control system is formed.

15. The motor family according to claim 14, wherein the tapping plate comprises at least two connecting elements, which are aligned parallel to an annular face of the tapping plate and project into the circumferential accommodation chamber.

16. A method for producing various electric motors, each with predetermined specifications, wherein several standard components are combined with each other in order to satisfy a previously determined specification, and wherein the standard components comprise one or more electric motors of different motor diameters and/or motor lengths, and/or one or more different position sensors for integration into the electric motors, and/or one or more different electronic control systems for controlling the electric motors, the method comprising the steps of:
providing a stator having a stator core and windings;
mounting a rotor in the stator core;
encasing the stator and forming a bearing for the rotor through an overmolding;
forming a tapping plate from a plastic material;
providing connecting contacts for electrical connection to the windings of the stator and connecting elements for connecting to an electronic control system;
arranging the stator, the rotor, and the tapping plate in a housing; and
arranging the electronic control systems in an accommodation chamber of the housing of the electric motor.

17. The motor of claim 1, wherein the electronic control system comprises an electronic positioning system.

18. The electric motor according claim 1, wherein the tapping plate is welded to or hot-pressed to or glued to and/or bonded to and/or cast with and/or overmolded with a plastic material or ceramic material.
